(19) United States
(12) Patent Application Publication
(10) Pub. No.: US 2007/0209983 A1
(43) Pub. Date: Sep. 13, 2007

(54) Hydraulic lubrication filter assembly

(75) Inventors: Douglas Rene Johnson, Waterloo, IA (US); Dwayne Alan Nystrom, Waterloo, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/374,535

(22) Filed: Mar. 13, 2006

(51) Int. Cl. B01D 35/14

(52) U.S. Cl. 210/132; 210/337; 210/338; 210/130

(57) ABSTRACT

A hydraulic filter assembly includes a housing mounted to a manifold which has a first inlet port, a second inlet port and an outlet port. The housing encloses a hollow outer filter element and a hollow inner filter element spaced apart from and received within the outer filter element. The housing and the outer filter element enclose an outer chamber therebetween, the outer filter element and the inner filter element enclose a middle chamber therebetween, and the inner filter element surround an inner chamber. The manifold has a first passage communicating the first inlet port to the inner chamber, a second passage communicating the second inlet port to the outer chamber, and a third passage communicating the middle chamber to the outlet port. As a result, fluid flows from the outer chamber to the middle chamber via the outer filter element and so that fluid flows from the inner chamber to the middle chamber via the inner filter element.

### BACKGROUND

The present invention relates to a filter assembly for a hydraulic lubrication system.

Agricultural tractors have hydraulic systems which include hydraulic pumps which supply pressurized hydraulic fluid to various hydraulically operated devices such as a steering system, a hitch system, selective control valves (SCVs) connected to hydraulic cylinders, and a transmission which includes hydraulically operated control valves and a hydraulic lubrication circuit. The SCVs have been located at different locations on the tractor, including middle and rear locations. For example, rear SCVs are connected by hydraulic couplers to hydraulic cylinders on an implement coupled to the tractor. The hydraulic pumps draw or suck hydraulic fluid from a sump or reservoir which may be formed by a housing such as a gear box housing. Contaminants can be introduced into a hydraulic system at the implement hydraulic components, the couplers, and at other points. Filter assemblies with dual concentric filter elements are known. But such known filter assemblies do not permit the filtering by separate filter elements two separate sources of fluid and combining the two filtered flows into a single outlet. It would be desirable to have a filter with two separate filter elements arranged in a compact assembly.

### SUMMARY

Accordingly, an object of this invention is to provide a compact two-element filter assembly for protecting a vehicle hydraulic system from contaminants.

This and other objects are achieved by the present invention, wherein a hydraulic filter assembly includes a housing mounted to a manifold which has a first inlet port, a second inlet port and an outlet port. The housing encloses a hollow outer filter element and a hollow inner filter element spaced apart from and received within the outer filter element. The housing and the outer filter element enclose an outer chamber therebetween, the outer filter element and the inner filter element enclose a middle chamber therebetween, and the inner filter element surrounds an inner chamber. The manifold has a first passage communicating the first inlet port to the inner chamber, a second passage communicating the second inlet port to the outer chamber, and a third passage communicating the middle chamber to the outlet port. As a result, fluid flows from the outer chamber to the middle chamber via the outer filter element and so that fluid flows from the inner chamber to the middle chamber via the inner filter element.

### BRIEF DESCRIPTION OF THE DRAWINGS

FIG. 1 is a simplified schematic diagram of a vehicle hydraulic system including a filter unit according to the present invention;

FIG. 2 is a sectional view along lines 2-2 of FIG. 1; and

FIG. 3 is a simplified schematic diagram of a vehicle hydraulic system including an alternate embodiment of the present invention.

### DETAILED DESCRIPTION

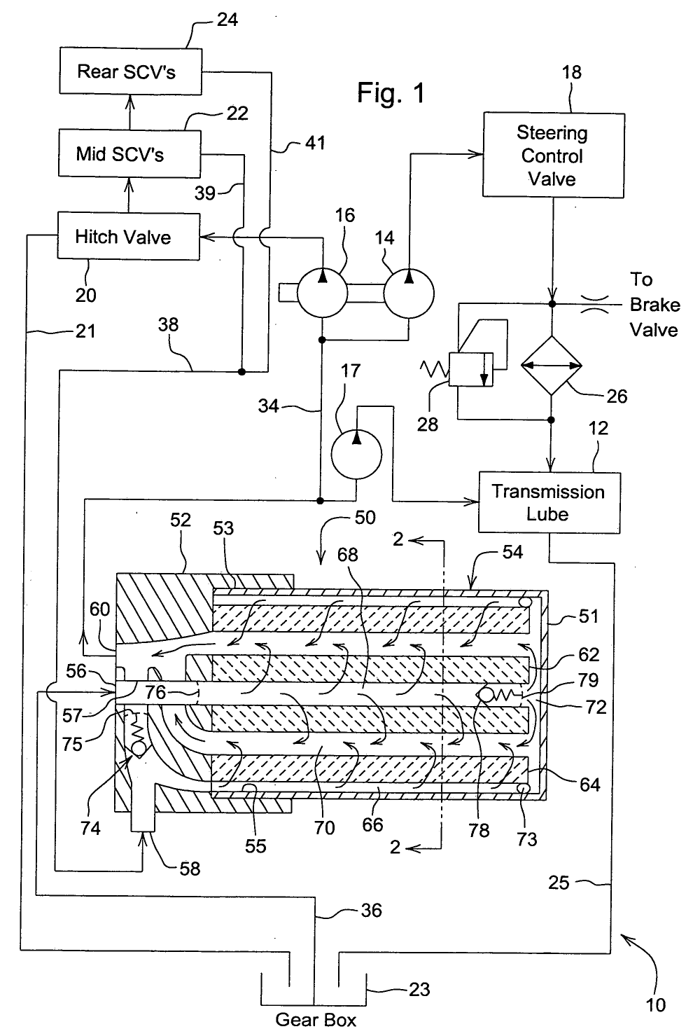

Referring to the FIG. 1, a vehicle hydraulic system 10 includes a component lube circuit 12, such as the lube circuit for the vehicle transmission (not shown). The system includes a low capacity hydraulic pump 14, a high capacity hydraulic pump 16, and a pump 17. The pumps could be either gear pumps or axial piston pumps. The low capacity pump 14 supplies pressurized hydraulic fluid to a hydraulic control unit 18, such as steering control valve. The high capacity pump 16 supplies pressurized hydraulic fluid to one or more control valve units, such as hitch control valve unit 20, a mid selective control valve (SCV) unit 22 and a rear SCV unit 24. Pump 17 supplies pressurized hydraulic fluid to the transmission lube circuit 12. Control valve units 20-24 are preferable connected in series. Hitch control valve unit 20 controls a tractor hitch cylinder (not shown). Mid SCV unit 22 and the rear SCV unit 24 may be connected by a conventional hydraulic coupler (not shown) to a cylinder (not shown) on an implement (not shown).

Hydraulic fluid is preferably communicated from the steering control valve 18 to the lube circuit 12 via cooler 26 and a cooler bypass valve 28. Bypass valve 28 is spring biased to a closed position and is urged to an open position by a pilot line connected to its inlet. A sump line 21 communicates hitch control valve 20 to a sump 23, such as a gear box sump. A sump line 25 communicates lube circuit 12 to the sump 23.

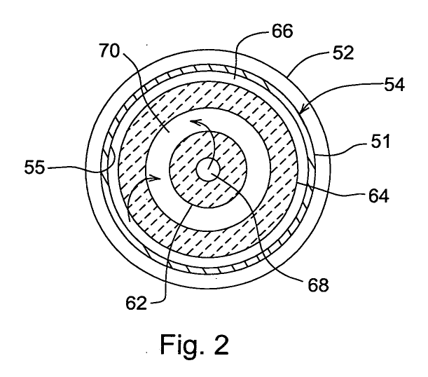

According to the present invention, the hydraulic system 10 includes a novel compact filter assembly 50. Referring now to FIGS. 1 and 2, filter assembly 50 includes a manifold 52 and a filter media hollow cylindrical housing 54. Housing 54 has a closed end 51 and an open end 53 which is sealingly received by the manifold 52. Manifold 52 includes a recess 55, a central sump inlet port 56 and inlet passage 57 which are communicated with sump 23 via line 36, an SCV return port 58 which is communicated with SCVs 22 and 24 via lines 38, 39 and 41, and a supply port 60 which is communicated to the inlets of pumps 14, 16 and 17 via line 34. Recess 55 sealingly receives the open end 53 of the housing 54.

Media housing 54 encloses an inner hollow annular cylindrical filter 62 and an outer hollow annular cylindrical filter 64. Housing 54 and filters 62 and 64 together define a first or outer annular inlet chamber 66, a second or central inlet chamber 68, an outlet chamber 70 which surrounds filter 62 and is surrounded by filter 64, and an end chamber 72. An annular sealing ring 73 between housing 54 and the outer end of filter 64 prevents direct fluid flow from chamber 66 to end chamber 72 and thereby forces fluid in chamber 66 to flow through outer filter 64.

Manifold 52 may include an optional conventional anti-drain valve (not shown) to prevent lubricating oil from flowing out of the manifold 52 via passage 57. An optional filter or strainer 76 filters fluid which flows through passage 57. Manifold may also include an optional return bypass valve 74 which allows fluid to flow through the manifold 52 from inlet 58 and chamber 66 to outlet 60 (bypassing filter 64) if the pressure in chamber 66 exceeds a certain threshold. An optional filter or strainer 75 filters fluid which flows through valve 74.

Filter assembly 50 may include a suction bypass valve 78 which allows one-way fluid flow from chamber 66 to end chamber 72 and bypass filter 62. An optional filter or strainer 79 filters fluid which flows through bypass valve 78.

As shown in FIG. 1, outlet port 60 is connected to the inlets of pumps 14, 16 and 17 via line 34. Inlet port 56 may be connected to sump 23 via line 36, and inlet port 58 may be connected to SCVs 22 and 24 via lines 38-41. In this case inner filter 62 operates as a suction filter and outer filter 64 operates as a return filter. As a result, fluid flowing from sump 23 to pumps 14, 16 and 17 is filtered by inner filter 62, and fluid flowing from SCVs 22 and 24 to pumps 14, 16 and 17 is filtered by outer filter 64.

Thus, in this design, the two separate filters are nested one inside the other and fit inside a housing. This housing may be formed by a transmission casting itself (not shown) or it may be a separate filter housing as shown in FIG. 1. This design is more compact and requires fewer parts (such as end caps) than does a filter assembly with two filter elements disposed end-to-end. This design is also more compact than a more conventional solution consisting of 2 separate filters with 2 manifolds.

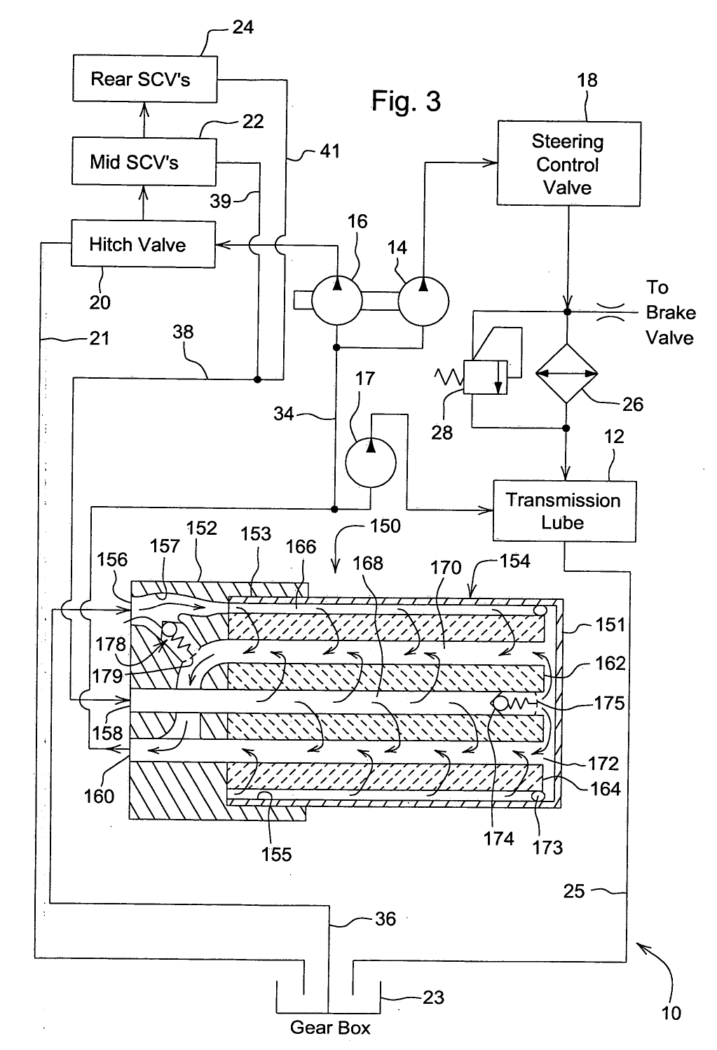

Referring now to FIG. 3, according to an alternate embodiment of the present invention, the hydraulic system 10 includes a novel compact filter assembly 150. Filter assembly 150 includes a manifold 152 and a filter media hollow cylindrical housing 154. Housing 154 has a closed end 151 and an open end 153 which is sealingly received by the manifold 152. Manifold 152 includes a recess 155, a sump inlet port 156 and inlet passage 157 which are communicated with sump 23 via line 36, a central SCV return port 158 which is communicated with SCVs 22 and 24 via lines 38, 39 and 41, and an outlet port 160 which is communicated to the inlets of pumps 14, 16 and 17 via line 34. Recess 155 sealingly receives the open end 153 of the housing 154.

Media housing 154 encloses an inner hollow annular cylindrical filter 162 and an outer hollow annular cylindrical filter 164. Housing 154 and filters 162 and 164 together define a first or outer annular inlet chamber 166, a second or central inlet chamber 168, an outlet chamber 170 which surrounds filter 162 and is surrounded by filter 164, and an end chamber 172. An annular sealing ring 173 between housing 154 and the outer end of filter 164 prevents direct fluid flow from chamber 166 to end chamber 172 and thereby forces fluid in chamber 166 to flow through outer filter 164.

Manifold 152 may include an optional conventional anti-drain valve (not shown) to prevent lubricating oil from flowing out of the manifold 152 via passage 157. An optional filter or strainer (not shown) may be inserted to filter fluid which flows through passage 157. Manifold may also include an optional return bypass valve 174 which allows fluid to flow from chamber 168 to outlet chamber 170 via end chamber 172 and bypass filter 162. An optional filter or strainer 175 filters fluid which flows through bypass valve 174.

Filter assembly 150 may include a suction bypass valve 178 which allows one-way fluid flow through the manifold 152 from inlet 156 to outlet 160 (bypassing filter 164) if the pressure in chamber 166 exceeds a certain threshold. An optional filter or strainer 179 filters fluid which flows through valve 178.

As shown in FIG. 3, outlet port 160 is connected to the inlets of pumps 14, 16 and 17 via line 34. Inlet port 156 may be connected to sump 23 via line 36, and inlet port 158 may be connected to SCVs 22 and 24 via lines 38-41. In this case outer filter 164 operates as a suction filter and inner filter 162 operates as a return filter. As a result, fluid flowing from sump 23 to pumps 14, 16 and 17 is filtered by outer filter 164, and fluid flowing from SCVs 22 and 24 to pumps 14, 16 and 17 is filtered by inner filter 162.

While the present invention has been described in conjunction with a specific embodiment, it is understood that many alternatives, modifications and variations will be apparent to those skilled in the art in light of the foregoing description. For example, the invention can be implemented with either filters or screens, and the term filter in the claims below is intended to be a generic term meaning either a filter or a screen. Accordingly, this invention is intended to embrace all such alternatives, modifications and variations which fall within the spirit and scope of the appended claims.

We claim:

1. A hydraulic filter assembly comprising:
a manifold having a recess, a first inlet port, a second inlet port and an outlet port; and
a filter unit having a housing, a hollow outer filter element mounted in the housing and a hollow inner filter element mounted in the housing, the housing having an open end sealingly received by the recess and having a closed end, the hollow inner filter element being spaced apart from and received within the outer filter element, the housing and the outer filter element enclosing an outer chamber therebetween, the outer filter element and the inner filter element enclosing a middle chamber therebetween, and the inner filter element surrounding an inner chamber; and
the manifold having a first passage communicating the first inlet port to the inner chamber, a second passage communicating the second inlet port to the outer chamber, and a third passage communicating the middle chamber to the outlet port so that fluid flows from the outer chamber to the middle chamber via the outer filter element and so that fluid flows from the inner chamber to the middle chamber via the inner filter element.

2. The hydraulic filter assembly of claim 1, further comprising:
a bypass valve 78 permitting one-way fluid flow from the inner chamber to the outer chamber and bypassing the filter elements if pressure in the inner chamber exceeds a threshold pressure.

3. The hydraulic filter assembly of claim 2, further comprising:
a bypass strainer for filtering fluid flow from the inner chamber to the outer chamber via the end chamber.

4. The hydraulic filter assembly of claim 1, further comprising:
a bypass valve 74 permitting one-way fluid flow through the manifold from one of the inlet ports to the outlet port if pressure in the one inlet port exceeds a threshold pressure.

5. The hydraulic filter assembly of claim 1, wherein:
the housing encloses an end chamber exposed to ends of both filter elements; and
a seal is mounted between the housing and an end of the outer filter element to prevent fluid flow directly from the outer chamber to the end chamber.

6. The hydraulic filter assembly of claim 1, further comprising:
a bypass valve 78 permitting one-way fluid flow from the inner chamber to the outer chamber and bypassing the filter elements if pressure in the inner chamber exceeds a threshold pressure; and
a bypass valve 74 permitting one-way fluid flow through the manifold from one of the inlet ports to the outlet port if pressure in the one inlet port exceeds a threshold pressure.

7. The hydraulic filter assembly of claim 6, wherein:
the housing encloses an end chamber exposed to ends of both filter elements; and
a bypass strainer filters fluid flow from the inner chamber to the outer chamber via the end chamber.

8. The hydraulic filter assembly of claim 6, further comprising:
a strainer in the manifold between the first inlet port and the inner chamber;

9. A hydraulic filter assembly comprising:
a manifold having a recess, a first inlet port, a second inlet port and an outlet port;
a housing having an open end sealingly received by the recess and having a closed end;
a hollow outer filter element mounted in the housing;
a hollow inner filter element mounted in the housing spaced apart from and received within the outer filter element;
the housing and the outer filter element enclosing a first inlet chamber therebetween;
the outer filter element and the inner filter element enclosing an outlet chamber therebetween;
the inner filter element surrounding a second inlet chamber; and
the manifold having a first passage communicating the first inlet port to one of the inlet chambers, a second passage communicating the second inlet port to the other inlet chamber, and a third passage communicating the outlet chamber to the outlet port so that fluid flows from the first inlet chamber to the outlet chamber via the outer filter element and so that fluid flows from the second inlet chamber to the outlet chamber via the inner filter element.

10. The hydraulic filter assembly of claim 9, further comprising:
a bypass valve 78 permitting one-way fluid flow from the inner chamber to the outer chamber and bypassing the filter elements if pressure in the inner chamber exceeds a threshold pressure.

11. The hydraulic filter assembly of claim 10, further comprising:
a bypass strainer for filtering fluid flow from the inner chamber to the outer chamber via the end chamber.

12. The hydraulic filter assembly of claim 9, further comprising:
a bypass valve 74 permitting one-way fluid flow through the manifold from one of the inlet ports to the outlet port if pressure in the one inlet port exceeds a threshold pressure.

13. The hydraulic filter assembly of claim 9, wherein:
the housing encloses an end chamber exposed to ends of both filter elements; and
a seal is mounted between the housing and an end of the outer filter element to prevent fluid flow directly from the outer chamber to the end chamber.

14. The hydraulic filter assembly of claim 9, further comprising:
a bypass valve 78 permitting one-way fluid flow from the inner chamber to the outer chamber and bypassing the filter elements if pressure in the inner chamber exceeds a threshold pressure; and
a bypass valve 74 permitting one-way fluid flow through the manifold from one of the inlet ports to the outlet port if pressure in the one inlet port exceeds a threshold pressure.

15. The hydraulic filter assembly of claim 14, wherein:
the housing encloses an end chamber exposed to ends of both filter elements; and
a bypass strainer filters fluid flow from the inner chamber to the outer chamber via the end chamber.

16. The hydraulic filter assembly of claim 14, further comprising:
a strainer in the manifold between the first inlet port and the inner chamber.
